(19) United States
(12) Patent Application Publication
(10) Pub. No.: US 2012/0106842 A1
(43) Pub. Date: May 3, 2012

(54) METHOD FOR IMAGE ENHANCEMENT BASED ON HISTOGRAM MODIFICATION AND SPECIFICATION

(75) Inventors: Chu-Song CHEN, Zhonghe City (TW); Lu-Hung Chen, Taichung City (TW); Yao-Hsiang Yang, Taipei City (TW)

(73) Assignee: National Chiao Tung University

(21) Appl. No.: 12/915,762

(22) Filed: Oct. 29, 2010

(51) Int. Cl. G06K 9/00

(52) U.S. Cl. 382/169

(57) ABSTRACT

This invention provides a method for image enhancement based on histogram modification and specification, which comprises the following steps, calculating a first cumulative distribution function for a gray levels of a first image; calculating a first transforming function by the first distribution function and a second distribution function; providing a second transforming function by a first equation or a second equation; providing the second transforming function, the second transforming function is close to the first transforming function; providing the second transforming function, the second transforming function is smooth low-pass filtering result of the first transforming function; and outputting a second image from the second transforming function.

### BACKGROUND OF THE INVENTION

1. Field of the Invention

The present invention relates to a method for image enhancement based on histogram modification and specification thereof, and is more particularly used to improve the contrast and gray levels of an image and to prevent from amplification of noise and production of visual artifacts.

2. Description of the Prior Art

The digital imaging technology has been developed for many years. The U.S. Pat. No. 5,995,656 teaches an image enhancement method using low-pass filtering and histogram equalization and a device thereof. In that, an input image is low-pass filtered, and then the histogram is equalized to become a contrast-enhanced signal. In this case, the desired histogram g is a uniform distribution for desired gray levels. The low-pass filtered signal is subtracted from the original image, and the subtracted value is added to the contrast-enhanced signal. Since the low-pass filtered signal has less noise than the original image, the contrast of the input image can be enhanced without amplifying so much noise.

However, due to the subtracted value, the histogram of the output image Y may be very different from g, and the mean of brightness cannot be controlled, which may cause flickering for image sequences. Furthermore, the slope of the transformation used in the equalization step may be large, which may create unpleasant visual artifacts.

The U.S. Pat. No. 5,923,383 teaches an image enhancement method using histogram equalization. This method is disclosed using a histogram equalization for an input image expressed in a predetermined number of gray levels. While calculating the probability density function of the gray levels of the input image, for use in histogram equalization, the numbers of occurrences of each gray level are constrained not to exceed a predetermined value. Then histogram equalization is performed on the input image based on the calculated probability density (or distribution) function. As a result, the mean brightness of the input image does not change significantly by the histogram equalization. Additionally, noise is prevented from being greatly amplified.

However, the modified histogram may be far from the original histogram due to the normalization step, and hence the histogram of the enhanced image may be very different to the desired histogram g, which is assumed to be uniform in this case. Furthermore, the invention cannot be directly applied when g is not uniform.

J. M. Gauch once presented a paper, Investigations of Image Contrast Space Defined by Variations on Histogram Equalization, CVGIP-1992, pp. 269-280. The paper considered the case when g is uniform. They blur the histogram of the input image by some low pass filter (e.g. Gaussian blur) and obtain a new histogram. Then the method normalizes the modified histogram so that the summation equals 1, and use this histogram to construct the transformation. However, the method described in this paper cannot be directly applied when g is not uniform i.e. general histogram specification, either, as the reasons described before.

Q. Wang and R. K. Ward once published Fast Image/Video Contrast Enhancement Based on Weighted Threshold Histogram Equalization, IEEE TCE 2007, pp. 757-764. They designed a normalization method based on power law to reduce the difference. However, their method cannot be applied to a case where g is non-uniform as described before.

Lastly, T. Arici, S. Dikbas and Y. Altunbasak recently published a papere, A Histogram Modification Framework and Its Application for Image Contrast Enhancement, IEEE TIP 2009, pp. 1921-1935. The paper is similar to the U.S. Pat. No. 5,923,383 described above. However, this method cannot be extended to the case when g is non-uniform as described before.

The above-mentioned methods are generally called the histogram equalization which causes the dynamic range of an image to be stretched, so that the density distribution of the resultant image is made more flat and the contrast of the image is enhanced as a consequence. However, such a widely-known feature of the histogram equalization becomes a defect in some practical cases. In particular, the mean brightness of the image may be changed significantly as a result of the equalization. Additionally, noise in the image is equalized along with the image signal. That may cause the noise to be greatly amplified, which deteriorates the quality of the image.

### SUMMARY OF THE INVENTION

In view of the problems presented in the prior art techniques, it is an object of the present invention to provide a method for image enhancement based on histogram modification and specification thereof to prevent amplifying the noise and producing the visual artifacts.

It is an object of the present invention to provide a method for image enhancement based on histogram modification and specification, which comprises the following steps, calculating a first cumulative distribution function for gray levels of a first image; calculating a first transforming function by the first distribution function and a second distribution function; providing a second transforming function by a first equation or a second equation; providing the second transforming function, the second transforming function is close to the first transforming function; providing the second transforming function, the second transforming function is smooth low-pass filtering result of the first transforming function; and outputting a second image from the second transforming function.

In the present invention, the first equation is

$${min}_{{T}_{2}} {\sum }_{k = 0}^{L} {( {T}_{2} ( k ) - T ( k ) )}^{2}$$

subjected to 0≦T₂′(s)≦t for all 0≦s≦L.

In the present invention, the second equation is

$${T}_{2}^{- 1} ( k ) = {\int }_{0}^{k} \frac{1}{Nh} {\sum }_{j = 1}^{N} K ( \frac{\hat{T} ( j ) - u}{h} ) d u .$$

In the present invention, the second transforming function is monotonically increasing function.

It is another object of the present invention to provide a method for image enhancement based on histogram modification and specification, which comprises the following steps, calculating a first cumulative distribution function for a gray levels of a first image; calculating a first transforming function by the first distribution function and a second distribution function; providing a second transforming function by a first equation or a second equation; providing the second transforming function, the second transforming function is close to the first transforming function; providing the second transforming function, the second transforming function is smooth low-pass filtering result of the first transforming function; providing the second transforming function, the second transforming function is monotonically increasing function; and outputting a second image from the second transforming function.

In the present invention, the first equation is

$${min}_{{T}_{2}} {\sum }_{k = 0}^{L} {( {T}_{2} ( k ) - T ( k ) )}^{2}$$

subjected to 0≦T₂′(s)≦t for all 0≦s≦L.

In the present invention, the second equation is

$${T}_{2}^{- 1} ( k ) = {\int }_{0}^{k} \frac{1}{Nh} {\sum }_{j = 1}^{N} K ( \frac{\hat{T} ( j ) - u}{h} ) d u .$$

This invention is the part of image enhancement technology. The advantage is easy to improve the quality of image. The feature of this invention is easy to practice too, and it is suitable to software and hardware. It also is suitable to the device which needs optimization of image gray levels. (eg. camera module of mobile phone, digital camera, video camera, and the system for adapting different gray levels like monitor system.)

As described above, the method for image enhancement based on histogram modification and specification thereof can provide the following advantages:

(1) The method for image enhancement based on histogram modification and specification can prevent from amplifying the noise.

(2) The method for image enhancement based on histogram modification and specification can lessen the production of the visual artifacts.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Further advantages of the disclosure are apparent by reference to the detailed description when considered in conjunction with the figures. The drawings disclose an illustrative embodiment of the present invention which serves to exemplify the various advantages and objects hereof, and process as follows:

FIG. 1 is a flowchart showing the image enhancement based on histogram modification and specification;

FIG. 2 is a flowchart showing the image enhancement based on histogram modification and specification;

FIG. 3 illustrates the effect of the image transforming process;

FIG. 4 is an un-processing image according to one embodiment of the present disclosure;

FIG. 5 is a processed image by known method;

FIG. 6 is processed image by the method of J. M. Gauch;

FIG. 7 is processed image by the method of Q. Wang and R. K. Ward;

FIG. 8 is processed image by the method of Lastly, T. Arici, S. Dikbas and Y. Altunbasak;

FIG. 9 is processed image by this invention of the equation 1; and

FIG. 10 is processed image by this invention of the equation 2.

### REFERENCE NUMERALS

S11˜S17 steps; and
S21˜S28 steps.

### DETAILED DESCRIPTION OF THE PREFERRED EMBODIMENT

If the image is not fine exposure or taken in case of extreme light, the gray levels distribution may focus dark or light excessively. For better visual effect, we can make image process by histogram modification and specification.

In a well-known histogram modification and specification, the method of constructing the gray-level transforming is listed below. Let X={Xᵢⱼ} be the gray levels of an inputted image. Xᵢⱼε{0, 1, 2, . . . , L} is the intensity of the (i,j) pixel. The L is the number of gray levels in the image (eg. In 8-bit image, L is 255.) Assume f is the histogram (probability distribution function) of X.

f(k)=nₖ/n, for k=1, 2, . . . , L.

The nₖ is the number of pixels of the k-th gray level. The n is the number of image pixels. Assume the F is the cumulative histogram (cumulative distribution function) of X.

$$F ( k ) = {\sum }_{s = 0}^{k} f ( s ) ,$$

for k=1, 2, . . . , L.

Let g be the target histogram, and G be the target cumulative histogram.

$$G ( k ) = {\sum }_{s = 0}^{k} g ( s ) ,$$

for k=1, 2, . . . , L

By the inverse probability integral transform, we find the function T,

T(k)=G⁻¹(F(k)).

The image Y=T(X) is the output image of the prior art. The function T is a monotonically increasing function. In prior art, the function T is often used to perform image transformation.

However, the inputted image often contains noise. X=U+ε means the image contains the noise. U is pure and clear image, ands is the noise whose mean is 0 and variance is σ². By the Mean Value Theorem, we get Y=T(X)=T(U)+T′(s)·ε, where T′ is the slope of T, and s falls between U and U+ε. The variance of noise in the function Y is T′(s)²σ², which is the original noise variance σ² multiplied by T′(s)².

In above derivation, we find that if the slope of the function T is larger, the noise will be amplified. The slope is determined by the curve of the function T. In addition, the function T containing large slopes may amplify the intensity changes of the original image and make additional visual artifacts.

The method we developed can improve the above drawbacks. This method is used to control the slope. The slope is determined by the curve of a function. This method makes the transformed gray levels of image almost fit the target histogram, and also prevents the unsuitable visual artifacts and avoids increasing noise of image. As mentioned above, when the inputted image X is transformed by the function T to get the image Y=T(X),

T(k)=G⁻¹(F(k)),

the gray levels distribution is close to the expectation g, where G is the target cumulative histogram.

$$G ( k ) = {\sum }_{s = 0}^{k} g ( s ) , for k = 1 , 2 , … , L$$

If the image X is transformed by a function T₂ that is close to the function T, the gray levels distribution will be also close to the desired g. Our goal is to find the function T₂ close to the function T, where the slope of T₂ shall be small. In other words, the curve of the function T₂ shall be smoother than that of T. Thus, the transformation function T₂ can prevent from amplifying the image noise. In addition, the function T₂ has also to be a monotonically increasing function, i.e., T₂′≦0, so as to keep the order of gray levels being the same as that of the original image.

The conditions are described below: we will find the function T₂ satisfying

Condition 1: the function T₂ is close to the function T;

Condition 2: the curve of function T₂ is smooth low-pass filtering result of the function T; and

Condition 3: the function T₂ is monotonically increasing function.

By equation 1:

$${min}_{{T}_{2}} {\sum }_{k = 0}^{L} {( {T}_{2} ( k ) - T ( k ) )}^{2} \qquad ( 1 )$$

subjected to 0≦T₂′(s)≦t for all 0≦s≦L

The t is given positive threshold, and the slope of the function T₂ is no larger than the given constant t. By choosing different t value controls the smoothness of the function T₂. When t is smaller, the curve of the function T₂ is smoother. When h is larger, the function T₂ is closer to original transform function T.

Because the method by equation 1 consumes more time and more computer resources, we used a simpler and faster equation, the equation 2:

Let T=l(T), the function l is any low pass filter like Gaussian filter. Construct the inverse of the function T₂(T₂⁻¹), which is

$${T}_{2}^{- 1} ( k ) = {\int }_{0}^{k} \frac{1}{Nh} {\sum }_{j = 1}^{N} K ( \frac{{T}^{⋒} ( j ) - u}{h} ) d u , \qquad ( 2 )$$

then T₂ can be obtained by T₂=(T₂⁻¹)⁻¹.

In Equation 2, the range of N, an integer, is 100 to 256. The K is the kernel function like Gaussian filter, and the h is used to control the slope of the curve of the function T₂. If h is larger, the slope of the function T₂ will be smaller. When h is smaller, the slope of the function T₂ is close to the T. It has been shown in Holger Dette, Natalle, Neumeyer and Kay F. Pilz, Bernoulli-2006, pp. 469-490 that the transform function T₂ obtained via equation 2 satisfies the conditions 1, 2, and 3.

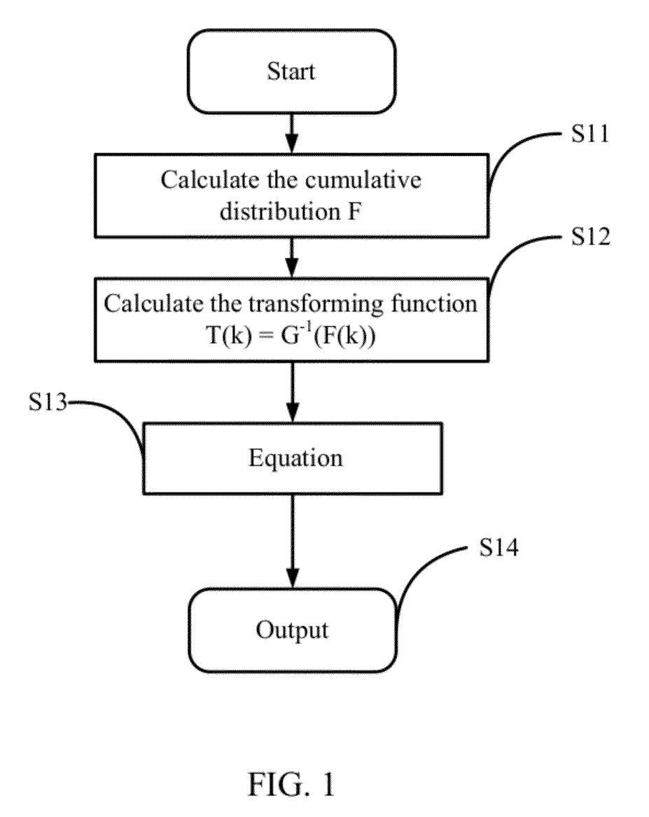

In FIG. 1, the steps of this invention are describing below:

(S11) Calculate the cumulative distribution F for the gray levels of image X;

(S12) Calculate the transforming function T(k)=G⁻¹(F(k)) by the cumulative distribution function F and the cumulative distribution G;

(S13) Provide the function T₂ by equation 1 or equation 2; and

(S14) Output the image Z, Z=T₂(X), and the function T₂ satisfies the condition 1 and the condition 2.

In first step, the F is the cumulative histogram of X. By the cumulative distribution function F and the cumulative distribution G, this invention calculates the transforming function T(k)=G⁻¹(F(k)). By choosing different t value controls the smoothness of the function T₂ in equation 1. When t is smaller, the curve of the function T₂ is smoother. When t is larger, the function T₂ is closer to original transform function T. But equation 1 consumes more time and more computer resources, we used a simpler and faster equation, the equation 2. In the equation 2, the T₂ can be obtained by T₂=(T₂⁻¹)⁻¹. The function T₂ satisfies the condition 1 and the condition 2. In the condition 1, the curve of function T₂ is smooth low-pass filtering result of the function T. Then, this method outputs the image Z, and Z=T₂(X).

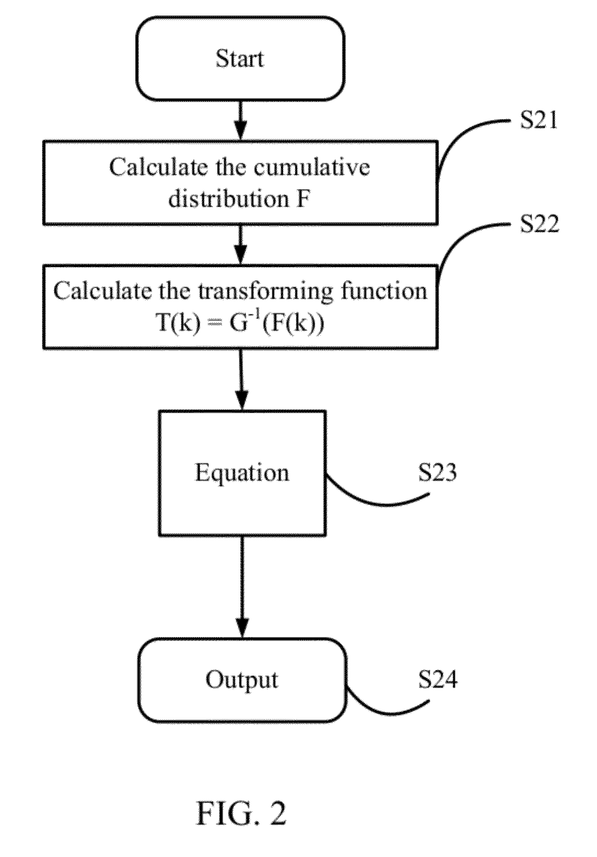

In FIG. 2, the steps of this invention are also describing below:
(S21) Calculate the cumulative distribution F for the gray levels of image X;
(S22) Calculate the transforming function T(k)=G⁻¹(F(k)) by the cumulative distribution function F and the cumulative distribution G;
(S23) Provide the function T₂ by equation 1 or equation 2; and
(S24) Output the image Z, Z=TAX), the function T₂ satisfies the condition 1, the condition 2, and the condition 3.

In first step, the F is the cumulative histogram of X. By the cumulative distribution function F and the cumulative distribution G, this invention calculates the transforming function T(k)=G⁻¹(F(k)). By choosing different t value controls the smoothness of the function T₂ in equation 1. When t is smaller, the curve of the function T₂ is smoother. When t is larger, the function T₂ is closer to original transform function T. By equation 1 consumes more time and more computer resources, we used a simpler and faster, the equation 2. In the equation 2, the T₂ can be obtained by T₂=(T₂⁻¹)⁻¹. The function T₂ satisfies the condition 1 and the condition 2. In the condition 1, the curve of function T₂ is smooth low-pass filtering result of the function T. In the condition 2, the curve of function T₂ is smooth low-pass filtering result of the function T. In the condition 3, the function T₂ is monotonically increasing function. Then, this method outputs the image Z, and Z=T₂(X).

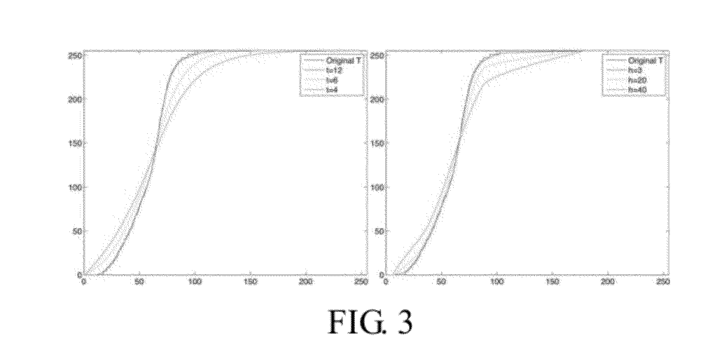

In FIG. 3, it shows the effect about t to the transforming function. In the left part of the figure, it shows the effect of t in the equation 1. When the t is smaller, the slope of the function T₂ is smaller. If the t is larger, the slope of the function T₂ will be closer to the function T. In the right part of the figure, it shows the effect of h in the equation 2. If the h is smaller, the slope of the function T₂ is smaller. When the h is larger, the slope of the function T₂ is close to the function T.

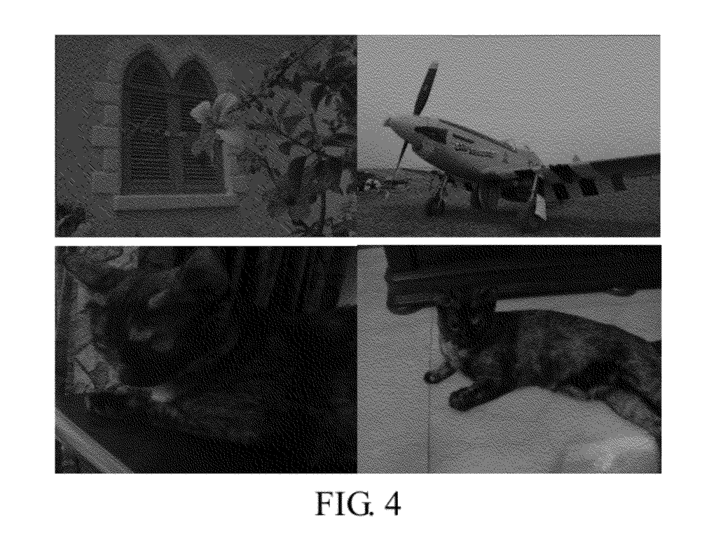

In FIG. 4, it shows the original image.

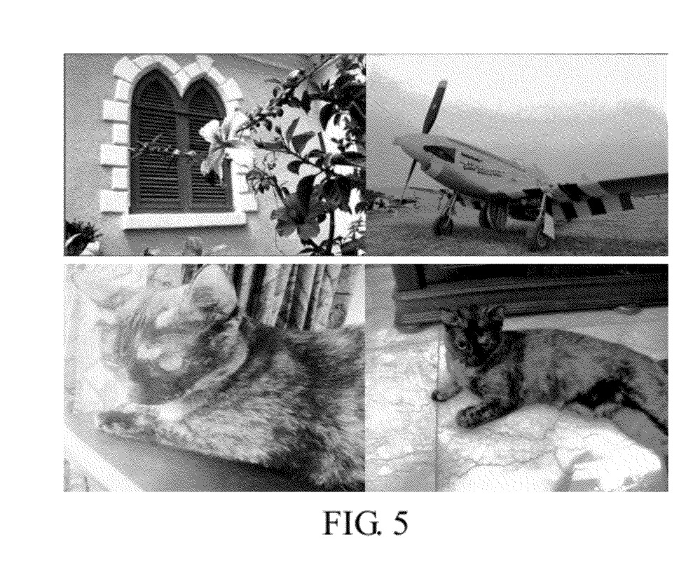

In FIG. 5, it shows the result of known histogram modification/specification. The noise is amplified obviously. It contains serious visual artifacts.

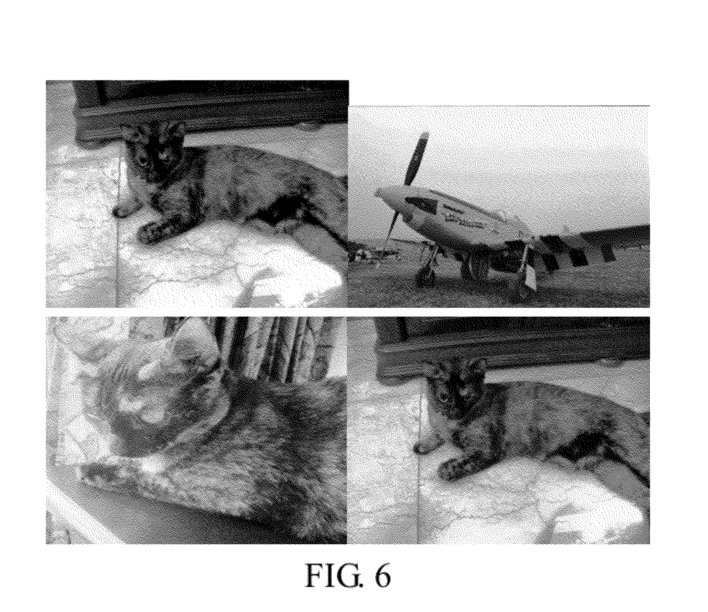

In FIG. 6, it shows the result by the method of J. M. Gauch, Investigations of Image Contrast Space Defined by Variations on Histogram Equalization, CVGIP-1992, pp. 269-280. The noise is still amplified obviously. It also contains visual artifacts.

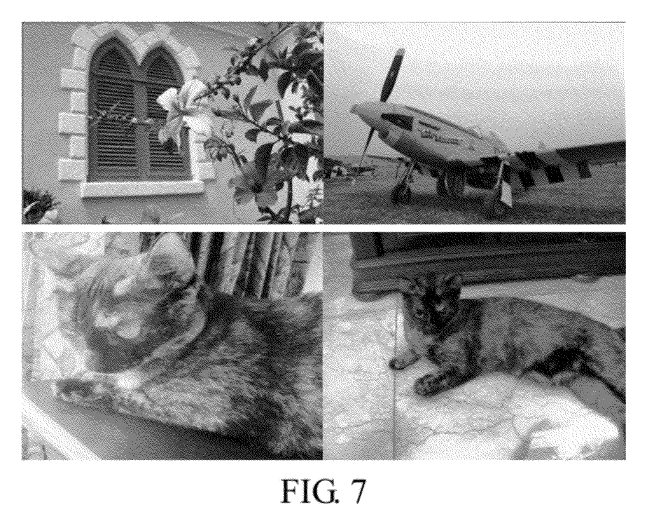

In FIG. 7, it shows the result by the method of Q. Wang and R. K. Ward once published Fast Image/Video Contrast Enhancement Based on Weighted Threshold Histogram Equalization, IEEE TCE 2007, pp. 757-764.

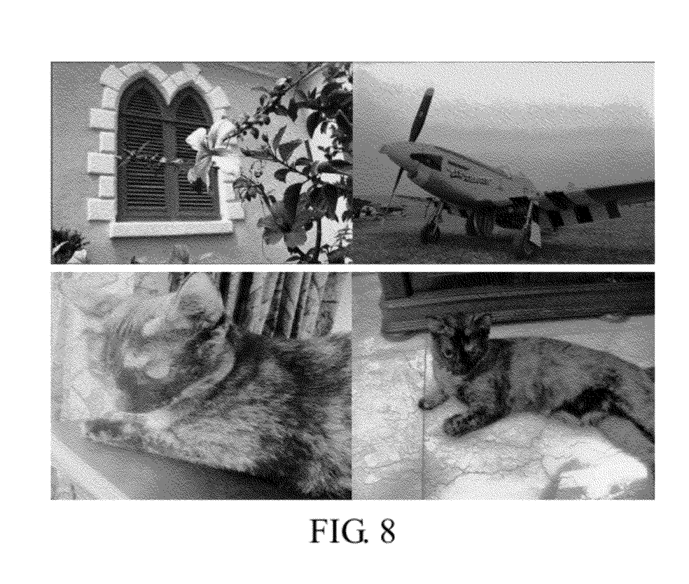

In FIG. 8, it shows the result by the method of Lastly, T. Arici, S. Dikbas and Y. Altunbasak, A Histogram Modification Framework and Its Application for Image Contrast Enhancement, IEEE TIP 2009, pp. 1921-1935. The noise is still amplified obviously. It also contains visual artifacts.

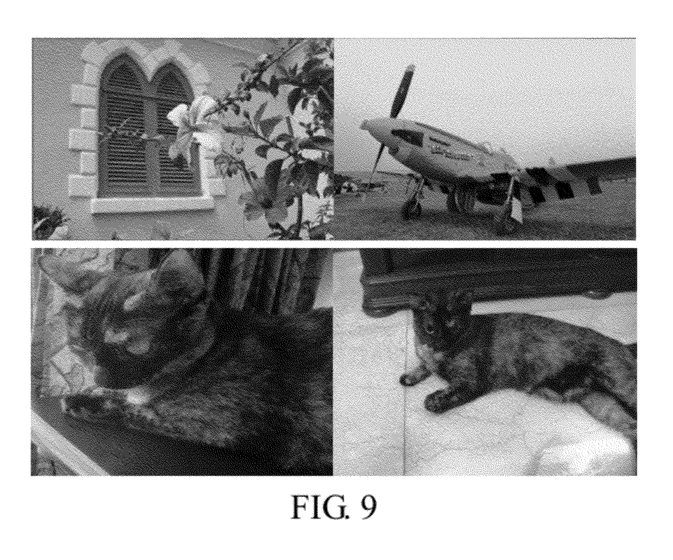

In FIG. 9, it shows the result by the method of the equation 1. The problem of amplified noise is improved, and it prevents produce the visual artifacts. Comparing the other methods, the method of the equation 1 has better visual effect obviously.

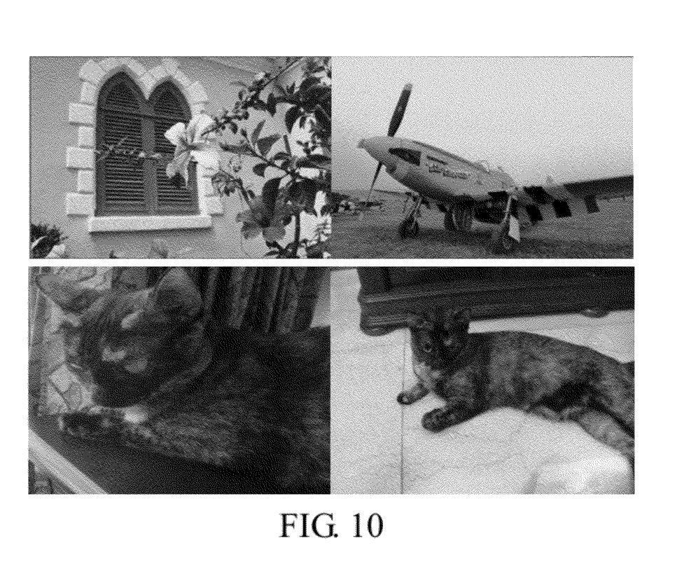

In FIG. 10, it shows the result by the method of the equation 2. The problem of amplified noise is improved, and it prevents produce the visual artifacts. Comparing the other methods, the method of the equation 2 has batter visual effect obviously.

Although the present invention has been described in terms of a preferred embodiment, it will be appreciated that various changes and modifications may be made to the described embodiment without departing from the spirit and scope of the claimed invention.

What is claimed is:

1. A method for image enhancement based on histogram modification and specification comprising:
calculating a first cumulative distribution function for a gray levels of a first image;
calculating a first transforming function by the first distribution function and a second distribution function;
providing a second transforming function by equations;
providing the second transforming function, the second transforming function is close to the first transforming function;
providing the second transforming function, the second transforming function is smooth low-pass filtering result of the first transforming function; and
outputting a second image from the second transforming function.

2. The method for image enhancement based on histogram modification and specification as claimed in claim 1, wherein the one of the equations is
$${min}_{{T}_{2}} {\sum }_{k = 0}^{L} {( {T}_{2} ( k ) - T ( k ) )}^{2}$$
subjected to 0≦T₂′(s)≦t for all 0≦s≦L.

3. The method for image enhancement based on histogram modification and specification as claimed in claim 1, wherein the one of the equations is
$${T}_{2}^{- 1} ( k ) = {\int }_{0}^{k} \frac{1}{Nh} {\sum }_{j = 1}^{N} K ( \frac{\hat{T} ( j ) - u}{h} ) d u .$$

4. The method for image enhancement based on histogram modification and specification as claimed in claim 1, wherein the second transforming function is monotonically increasing function.

5. A method for image enhancement based on histogram modification and specification comprising:
calculating a first cumulative histogram for the gray levels of a first image;
calculating a first transforming function by the first distribution function and a second distribution function;
providing a second transforming function by equations;
providing the second transforming function, the second transforming function is close to the first transforming function;
providing the second transforming function, the second transforming function is low-pass filtering result of the first transforming function;
providing the second transforming function, the second transforming function is smooth monotonically increasing function; and
outputting a second image from the second transforming function.

6. The method for image enhancement based on histogram modification and specification as claimed in claim 1, wherein one of the equation is
$${min}_{{T}_{2}} {\sum }_{k = 0}^{L} {( {T}_{2} ( k ) - T ( k ) )}^{2}$$
subjected to 0≦T₂′(s)≦t for all 0≦s≦L.

7. The method for image enhancement based on histogram modification and specification as claimed in claim 1, wherein one of the equation is
$${T}_{2}^{- 1} ( k ) = {\int }_{0}^{k} \frac{1}{Nh} {\sum }_{j = 1}^{N} K ( \frac{\hat{T} ( j ) - u}{h} ) d u .$$
